(19) United States
(12) Patent Application Publication
(10) Pub. No.: US 2014/0082208 A1
(43) Pub. Date: Mar. 20, 2014

(54) METHOD AND APPARATUS FOR MULTI-USER CONTENT RENDERING

(71) Applicant: NOKIA CORPORATION, Espoo (FI)

(72) Inventor: Juha Ojanperä, Nokia (FI)

(73) Assignee: NOKIA CORPORATION, Espoo (FI)

(21) Appl. No.: 13/622,441

(22) Filed: Sep. 19, 2012

(51) Int. Cl. G06F 15/16

(52) U.S. Cl. 709/231

(57) ABSTRACT

A method, apparatus, and computer program product are provided in order to capture and share audio and/or video content in a multi-user environment. In the context of a method, audio and/or video content is captured and selected to be uploaded to be shared with other users. The method generates a first data part of the selected content and a second data part of the selected content. The first data part comprises audio and video snapshots of the selected content and the second data part comprises a video of the selected content. The method also causes the first data part of the upload to be transmitted to a content server first, with the second data part being transmitted to the content server later. A corresponding apparatus and a computer program product are also provided.

### TECHNOLOGICAL FIELD

An example embodiment of the present invention relates generally to multi-user content and, more particularly, to the capturing and rendering of content in a multi-user environment.

### BACKGROUND

In multi-user content sharing, users located within an environment may each capture audio and/or visual content of events occurring within the environment with their individual audio/visual capture devices. These users may then upload the captured audio/visual content to a multi-user content server, where it may be shared with other users. The capturing devices may be arbitrarily positioned throughout the event space to capture the event. Location data and/or positioning data of the devices may be captured along with the audio/visual content and uploaded to the multi-user content server. The multi-user content server may use the location and/or position data to provide various listening and/or viewing points to a user for selection when downloading/streaming the captured content. The multi-user content server may then combine the uploaded content from the plurality of devices to provide the event content to users. In this regard, a user may select a particular listening/viewing point for the captured event and the multi-user content server may render mixed content from the uploaded content to reconstruct the event space.

To provide multi-user rendered content for sharing with other users, content from multiple users must first be uploaded to the multi-user content server. As video recording capabilities are advancing, the size of the recorded video data tends to increase. Typical mobile video recording is approaching full high definition (HD) video recording which has a resolution of 1920 pixels×1080 pixels per frame (1080p) and a video frame rate of 24, 25, or 30 frames per second (fps). With state of the art video encoding techniques, typical video recording may consume about 143 MB/min. The video bitrate is so high that it will have implications to the experience of multi-user video content services. One bottleneck is that the video upload takes so much time that the delay before any multi-user rendered content is available for end user consumption is so long that the end user may have a negative experience, that is, users are most likely not willing to wait tens of minutes for content to become available.

### BRIEF SUMMARY

A method, apparatus and computer program product are therefore provided according to an example embodiment of the present invention in order to capture and share audio and/or video content in a multi-user environment. In this regard, the method, apparatus and computer program product of an example embodiment may capture audio and/or video content, such as with a mobile device, and upload the content to a multi-user content server to share with other users. A first data part comprising audio and video snapshots of the selected content and a second data part comprising video may be generated from the content to be uploaded, where the second data part contains a larger amount of data to be transmitted than the first data part. The first data part of the upload may be transmitted to a content server first to allow fast availability of shared content, with the second data part being transmitted to the content server later to provide higher quality shared content. By splitting the selected content into a first data part and a second data part and transmitting the data parts separately, the first data part may be quickly received at the content server thereby allowing the selected content to be shared sooner than if the original selected content had to be received before sharing.

In one embodiment, a method is provided that at least includes determining captured content to be shared in a multi-user environment. The method of this embodiment also includes determining a first data part upload of the determined content, wherein the first data part upload comprises audio and one or more video snapshots of the determined content and causing the first data partupload to be transmitted. The method of this embodiment also causes a second data part upload to be transmitted, wherein the second data part upload comprises a video of the determined content that includes more frames than the first data part upload.

In one embodiment, the first data part upload further comprises one or more still images related to the captured content. In one embodiment, sensor data is also determined corresponding to the captured content. In some embodiments, the video snapshots and/or still images may be selected for the first data part upload based on timestamps and/or the sensor data.

The method of one embodiment may include receiving a first data part upload of content, wherein the first data part upload comprises audio and one or more video snapshots of the content. The method may determine a common timeline for the uploaded content. The method may further include generating an audio track for the common timeline; mapping the one or more video snapshots to the common timeline; and generating rendered content for the common timeline using the audio track and the mapped video snapshots. The method may further cause the rendered content to be transmitted.

In one embodiment, the first data part upload further comprises one or more still images and the method further comprises mapping the one or more still images to the common timeline. In some embodiments, the common timeline may be determined by aligning two or more uploaded audio tracks. In some embodiments, generating an audio track for the common timeline may comprise mixing two or more overlapping audio tracks as a function of time.

In one embodiment, the generating the rendered content may further comprise providing a first video snapshot when it first appears in the common timeline and replacing the first video snapshot with a second video snapshot when the second video snapshot first appears in the common timeline. In some embodiments, where a still image has a corresponding timestamp that is outside the common timeline, said still image may be randomly mapped to the common timeline.

In another embodiment, an apparatus is provided that includes at least one processor and at least one memory including computer program instructions with the at least one memory and the computer program instructions configured to, with the at least one processor, cause the apparatus at least to determine captured content to be shared in a multi-user environment. The at least one memory and the computer program instructions of this embodiment are also configured to, with the at least one processor, cause the apparatus to determine a first data part upload of the determined content, wherein the first data part upload comprises audio and one or more video snapshots of the determined content and cause the first data part upload to be transmitted. The at least one memory and the computer program instructions are also configured to, with the at least one processor, cause the apparatus of this embodiment to cause a second data part upload to be transmitted, wherein the second data part upload comprises a video of the determined content that includes more frames than the first data part upload.

In one embodiment, the first data part upload further comprises one or more still images related to the captured content. The at least one memory and the computer program instructions of one embodiment may be further configured to, with the at least one processor, cause the apparatus to determine sensor data corresponding to the captured content. In some embodiments, the at least one memory and the computer program instructions may be further configured to, with the at least one processor, cause the apparatus to select the video snapshots and/or still images for the first data part upload based on timestamps and/or the sensor data.

In another embodiment, an apparatus is provided that includes at least one processor and at least one memory including computer program instructions with the at least one memory and the computer program instructions configured to, with the at least one processor, cause the apparatus at least to receive a first data part upload of content, wherein the first data part upload comprises audio and one or more video snapshots of the content. In this embodiment, the at least one memory and the computer program instructions may be further configured to, with the at least one processor, cause the apparatus to determine a common timeline for the uploaded content. The at least one memory and the computer program instructions may be further configured to, with the at least one processor, cause the apparatus to generate an audio track for the common timeline; map the one or more video snapshots to the common timeline; and generate rendered content for the common timeline using the audio track and the mapped video snapshots. The at least one memory and the computer program instructions may be further configured to, with the at least one processor, cause the apparatus to cause the rendered content to be transmitted.

In a further embodiment, a computer program product is provided that includes at least one non-transitory computer-readable storage medium bearing computer program instructions embodied therein for use with a computer with the computer program instructions including program instructions configured to determine captured content to be shared in a multi-user environment. The computer program instructions of this embodiment also include program instructions configured to determine a first data part upload of the determined content, wherein the first data part upload comprises audio and one or more video snapshots of the determined content and cause the first data part upload to be transmitted. The computer program instructions of this embodiment also include program instructions configured to cause a second data part upload to be transmitted, wherein the second data part upload comprises a video of the determined content that includes more frames than the first data part upload.

In one embodiment, the first data part upload further comprises one or more still images related to the captured content. The computer program instructions of some embodiments also include program instructions configured to determine sensor data corresponding to the captured content. The computer program instructions of some embodiments also include program instructions configured to select the video snapshots and/or still images for the first data part upload based on timestamps and/or the sensor data.

In another embodiment, a computer program product is provided that includes at least one non-transitory computer-readable storage medium bearing computer program instructions embodied therein for use with a computer with the computer program instructions including program instructions configured to receive a first data part upload of content, wherein the first data part upload comprises audio and one or more video snapshots of the content. In this embodiment, the computer program instructions may be further configured to determine a common timeline for the uploaded content. The computer program instructions may be further configured to generate an audio track for the common timeline; map the one or more video snapshots to the common timeline; and generate rendered content for the common timeline using the audio track and the mapped video snapshots. The computer program instructions may be further configured to cause the rendered content to be transmitted.

In another embodiment, an apparatus is provided that includes at least means for determining captured content to be shared in a multi-user environment, means for determining a first data part upload of the determined content, wherein the first data part upload comprises audio and one or more video snapshots of the determined content, and means for causing the first data part upload to be transmitted. The apparatus of this embodiment also includes means for causing a second data part upload to be transmitted, wherein the second data part upload comprises a video of the determined content that includes more frames than the first data part upload.

In another embodiment, an apparatus is provided that includes at least means for receiving a first data part upload of content, wherein the first data part upload comprises audio and one or more video snapshots of the content; means for determining a common timeline for the uploaded content; means for generating an audio track for the common timeline; means for mapping the one or more video snapshots to the common timeline; and means for generating rendered content for the common timeline using the audio track and the mapped video snapshots. The apparatus of this embodiment further includes means for causing the rendered content to be transmitted.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a recording environment where multi-user content may be captured and shared in accordance with an example embodiment of the present invention;

FIG. 2 is a block diagram of an apparatus that may be specifically configured in accordance with an example embodiment of the present invention;

FIG. 3 is an illustration of event content capture in accordance with an example embodiment of the present invention;

FIG. 4 is a flow chart illustrating operations performed by an apparatus of FIG. 2 that is specifically configured in accordance with an example embodiment of the present invention;

FIG. 5 is a flow chart illustrating operations performed by an apparatus in accordance with an example embodiment of the present invention; and

FIG. 6 is a timing diagram of captured and rendered content in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment of the present invention to capture and render multi-user audio and/or video content. In this regard, a method, apparatus and computer program product of an example embodiment may capture audio and/or video content in an environment and upload the captured content for sharing with other users. In some of the embodiments, the content upload is split into a first data part and a second data part to provide faster availability of the multi-user content, where the second data part contains a larger amount of data to be transmitted than the first data part.

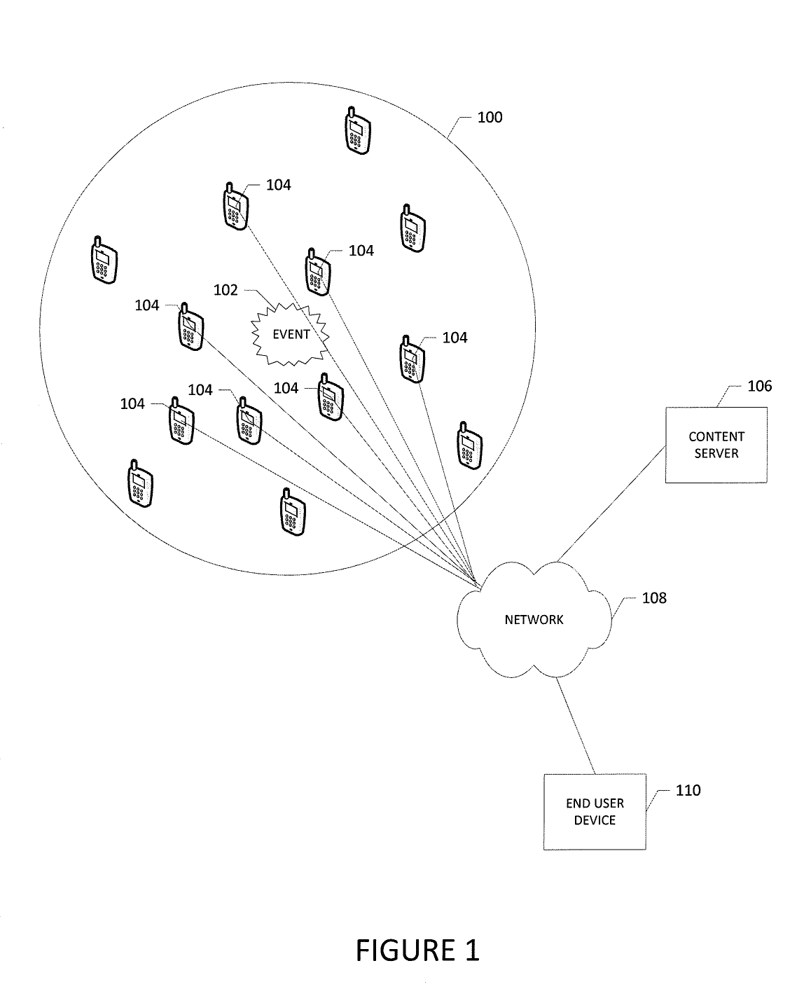

FIG. 1 illustrates a multi-user environment where an example embodiment of the present invention may be used. The environment 100 consists of a plurality of mobile devices 104 that are arbitrarily positioned within the environment to capture audio and/or video of an event 102. The mobile device 104 may be embodied as a variety of different mobile devices including as a mobile telephone, a personal digital assistant (PDA), a laptop computer, a tablet computer, a camera, a video recorder, or any of numerous other computation devices, content generation devices, content consumption devices or combinations thereof. Although described herein in conjunction with mobile devices, the environment may include one or more fixed or stationary devices, such as one or more fixed cameras, a desktop computer, or the like, in addition to or instead of the mobile devices.

The content captured by one of the plurality of mobile devices 104 may be uploaded immediately or may be stored and uploaded at a future time. The plurality of mobile devices 104 may also capture position data corresponding to the location where the content is being captured, such as through the use of Global Positioning System (GPS) coordinates, Cellular Identification (Cell-ID), or Assisted GPS (A-GPS). The plurality of mobile devices 104 may also capture direction/orientation data corresponding to the recording direction/orientation, such as by using compass, accelerometer or gyroscope data. The captured audio and/or video data from a mobile device 104 is then transmitted through network 108, such as to a multi-user content server 106. In this regard, network 108 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, network 108 may include a cellular radio access network, an 802.11, 802.16, 802.20, and/or WiMax network. Further, the network 108 may include a public network, such as the Internet, a private network, such as an intranet, or combinations thereof.

To minimize the lead time required before any multi-user rendered content is available to end users, the selected content may be made available quickly to the multi-user content server 106. As mentioned previously, full HD (1920 pixels x1080 pixels @ 30 fps) requires about 143 MB/min which translates to a video rate of about 19 Mbits/s. Due to network limitations, an upload of this size could take significantly more time than the duration of the selected video. Thus, captured content is not always available at the content server in a reasonable amount of time. If captured content is not available at the content server, then rendered content cannot be provided for end user viewing which in turn lowers the appeal for multi-user content rendering services. To provide for fast response time, certain embodiments of the present invention split the upload process into a first, low data part and a second, high data part. The first low data part of the selected content provides a low response time in the end-to-end context, albeit with a lower quality video, and the second high data part of the selected content fulfills user expectations, such as by providing high quality video, for the multi-user rendered content. The first low data part is uploaded first to the content server followed by the upload of the second high data part. The first low data part may be uploaded quickly so as to provide some initial content for the user with the second high data part taking longer to upload but providing enhanced video quality.

The multi-user content server 106 receives the uploaded content from the plurality of mobile devices 104 and may track the position data and the direction/orientation data. The multi-user content server 106 may combine the captured content from one or more mobile devices 104, such as one or more mobile devices that are in close proximity, to provide rendered content to be shared with end users. The multi-user content server 106 may use the position and/or direction/orientation data, for example, to provide a map for an end user of the available listening/viewing positions for captured content of an event.

After content from multiple users is available at the multi-user content server 106, the content may be rendered such that the downloaded/streamed content utilizes content from the different users in various ways. End users may be offered content that represents the multi-user content from various points of view that has been created in various manners, such as by equally sharing content from different users, selecting the best view as a function of time, maximizing or minimizing the viewing experience (that is, for each view select the view that is the most different from the different users or for each view select the view that is most similar from the different users), etc.

An end user may select content on the multi-user content server 106 that corresponds to a particular listening and/or viewing position at an event that the end user wishes to receive through end user device 110. The end user device 110 may be embodied as a variety of different mobile devices including as a mobile telephone, a personal digital assistant (PDA), a laptop computer, a tablet computer, a camera, a video recorder, an audio/video player, or any of numerous other computation devices, content generation devices, content consumption devices or combinations thereof. The end user device 110 may alternatively be embodied as a variety of different stationary or fixed computing devices, such as a desktop computer, a television, a game console, a multimedia device, or the like. Multi-user content server 106 may then render content corresponding to the selected listening/viewing position that the end user selected and cause the rendered content to be transmitted to end user device 110. Alternatively, if the proximity of the captured content is small, the multi-user content server 106 may provide only a single listening/viewing position to the end user.

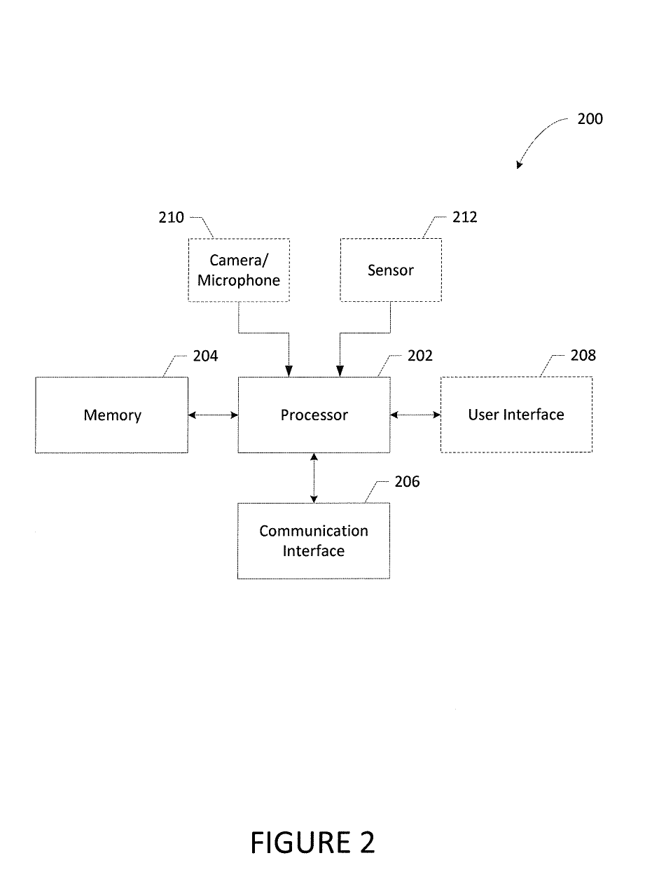

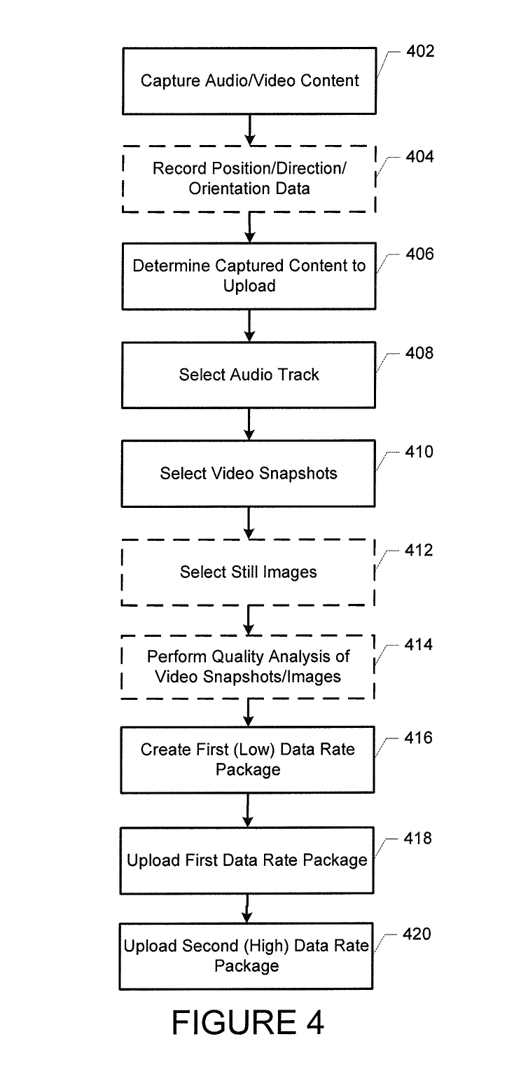

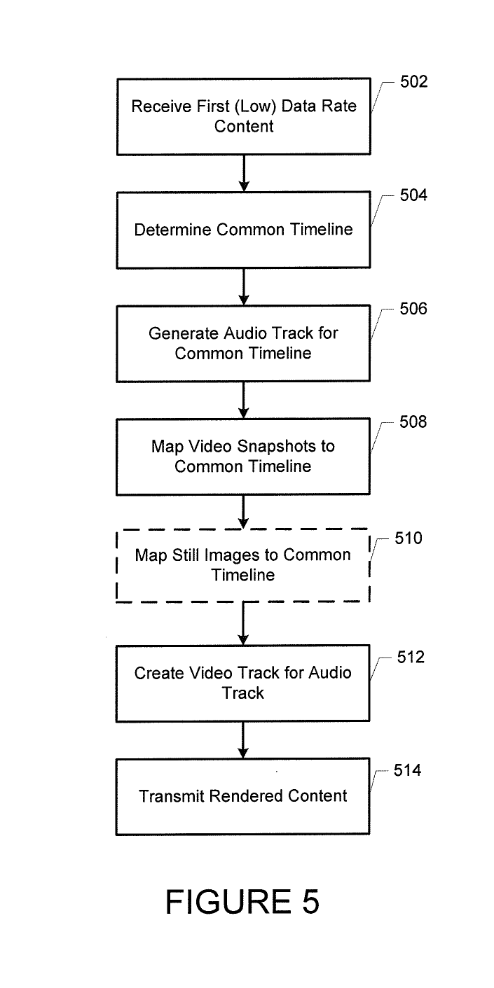

The system of an embodiment of the present invention may include an apparatus 200 as generally described below in conjunction with FIG. 2 for performing one or more of the operations set forth by FIGS. 4 and 5 and also described below. In this regard, the apparatus may be embodied by the mobile device 104, end user device 110 or content server 106 of FIG. 1.

It should also be noted that while FIG. 2 illustrates one example of a configuration of an apparatus 200 for capturing and rendering multi-user content, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 2, the apparatus 200 for capturing and rendering multi-user content in accordance with one example embodiment may include or otherwise be in communication with one or more of a processor 202, a memory 204, a communication interface 206, a user interface 208, a camera/microphone 210 and a sensor 212. In instances in which the apparatus is embodied by an end user device 110, the apparatus need not necessarily include a camera/microphone and a sensor and, in instances in which the apparatus is embodied by a content server 106, the apparatus need not necessarily include a user interface, a camera/microphone and a sensor. As such, these components have been illustrated in dashed lines to indicate that not all instantiations of the apparatus include those components.

In some embodiments, the processor (and/or co-processors or any other processing circuitry assisting or otherwise associated with the processor) may be in communication with the memory device via a bus for passing information among components of the apparatus. The memory device may include, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor 202. Additionally or alternatively, the memory device could be configured to store instructions for execution by the processor.

In some embodiments, the apparatus 200 may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 206 may be any means such as a device or circuitry embodied in either hardware or a combination of hardware and software that is configured to receive and/or transmit data from/to a network and/or any other device or module in communication with the apparatus 200, such as by supporting communications with the multi-user content server 106. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The apparatus 200 may include a user interface 208 that may, in turn, be in communication with the processor 202 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. The processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

In some example embodiments, such as instances in which the apparatus is embodied as a mobile device 104, the apparatus 200 may include an audio and video capturing element, such as a camera/microphone 210, video module and/or audio module, in communication with the processor 202. The audio/video capturing element may be any means for capturing an image, video and/or audio for storage, display or transmission. For example, in an example embodiment in which the audio/video capturing element is a camera, the camera may include a digital camera capable of forming a digital image file from a captured image. As such, the camera may include all hardware (for example, a lens or other optical component(s), image sensor, image signal processor, and/or the like) and software necessary for creating a digital image file from a captured image and/or video. Alternatively, the camera may include only the hardware needed to view an image, while a memory device 204 of the apparatus stores instructions for execution by the processor in the form of software necessary to create a digital image file from a captured image. In an example embodiment, the camera may further include a processing element such as a co-processor which assists the processor in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

As shown in FIG. 2, in instances in which the apparatus is embodied as a mobile device 104, the apparatus 200 may also include a sensor 212, such as a GPS receiver, a compass, an accelerometer, and/or a gyroscope that may be in communication with the processor 202 and may be configured detect changes in position, motion and/or orientation of the apparatus.

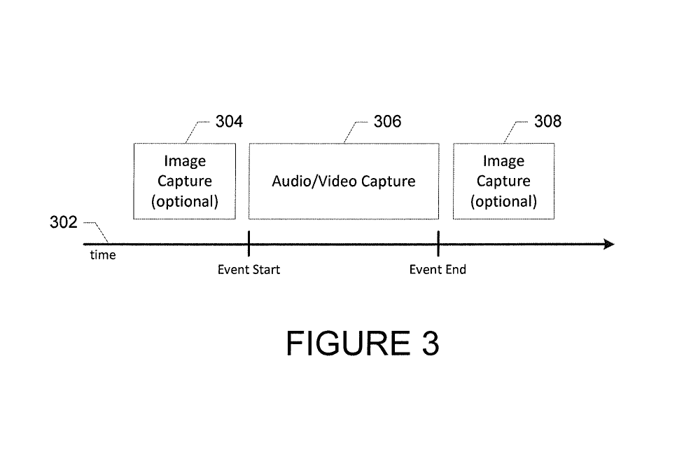

FIG. 3 shows an example of event capture as a function of time, as provided in some embodiments. The event capture consists of audio/video capture preceded and followed by optional still image captures. Time line 302 illustrates the timeframe for an event capture. Prior to the event start, an apparatus, such as embodied by a mobile device 104, may capture still images 304 of the current environment, such as by activation of a camera by the user. The audio/video recording portion of the apparatus may be activated at the event start to begin the audio/video capture 306. At the end of the event, the audio/video recording portion of the apparatus may be stopped to complete the audio/video capture 306. After the event ends, the apparatus may again capture still images 308 of the environment. The audio/video capture 306 and the still image captures 304 and 308 may comprise the captured content that is to be uploaded to the multi-user content server 106 to be shared with end users.

The method, apparatus, and computer program product may now be described in conjunction with the operations illustrated in FIG. 4. In this regard, the apparatus 200 may include means, such as the processor 202, the camera/microphone 210, or the like, for capturing audio and/or video content of an event. See block 402 of FIG. 4. In one embodiment, a camera of mobile device 104 captures audio/video data 306 and still images 304 and 308 before, during, and after an event of interest.

As shown in block 404 of FIG. 4, the apparatus 200 may also include means, such as the processor 202, sensor 212, or the like, for determining sensor data that describes the behavior of the device during recording. Sensor data may include, but is not limited to, position data, such as from GPS coordinates, Cell-ID or A-GPS, direction/orientation data, including one or more of accelerometer or gyroscope data describing the device movement during image capture compass data that describes the compass angle of the device during the image capture, and data from an image sensor such as describing the lighting conditions and focus related data (e.g., zoom level, etc.) during image capture. The sensor data may be included in the captured content uploaded to the multi-user content server 106 and used by the multi-user content server 106 to combine content from multiple users and to determine viewing/listening positions for the captured content.

The captured content may be uploaded to the multi-user content server 106 in real-time or may be uploaded to the multi-user content server 106 at a future time. As shown in block 406 of FIG. 4, the apparatus 200 may include means, such as the processor 202 or the like, for determining captured content that is to be uploaded to the multi-user content server 106. An apparatus may determine the captured content to be uploaded, for instance, through the use of settings programmed in advance of any capturing or by the selection of particular content by a user. For example, a user may provide an indication through user interface 208 that captured content is to be uploaded in real-time before the apparatus begins an operation to capture audio/video data, such as by setting a parameter through the user interface 208. Thus, the processor may determine that all captured content is to be uploaded. Alternatively, a user may review stored audio/video data (e.g. video/audio recordings of previous events) and provide an indication through user interface 208 that selected stored data (e.g. one or more video/audio recordings) is to be uploaded to the multi-user content server 106. As such, the processor may determine that the selected content is to be uploaded.

In some embodiments, the upload operation for the selected content is split into two parts, a first low data part and a second high data part. The first data part of the upload may comprise an audio track of the selected content, a set of video snapshots of the selected content, where video snapshots may be single image frames captured from the video or segments of video frames captured from the video, and optionally, a set of still images taken before and after an event and corresponding to the content. The second data part of the upload may comprise the full video/audio recording of the selected content or at least a video recording of the selected content that includes more frames than the first data part.

As shown in block 408 of FIG. 4, the apparatus 200 may also include means, such as the processor 202 or the like, for selecting the audio track from the content that is to be uploaded to the multi-user content server 106.

The apparatus 200 may also include means, such as the processor 202 or the like, for selecting video snapshots for the selected content. See block 410 of FIG. 4. In one embodiment, the apparatus 200 determines timestamps for the video snapshots with the timestamps defining the time instants along the capturing timeline where a video snapshot, when extracted from the captured video content in the vicinity of the determined timestamp, provides an interesting or representative view to the video content.

In some embodiments, more than one video snapshot may be provided to get the best views and summary of the video content. The time instants may be determined by the processor in one embodiment by analyzing the captured sensor data of the selected video and determining the preferred time instances for the video snapshots. The preferred time instances may be defined in various manners. For example, accelerometer or gyroscope information may be used by the processor to find time instants where the apparatus is not tilted (up or down) and the shake of the apparatus is minimal. The compass information may be used by the processor to find time instants where the apparatus is turned toward a certain compass angle. For example, it may be advantageous to create a histogram of the compass values and define the preferred time instances to be those associated with the compass range values that appear most in the histogram. This approach is typically able to capture interesting or representative views since a typical assumption is that if a user is holding the apparatus toward a certain compass angle for a reasonably long period of time, then this angle and the video content probably contains something of interest. Data from an image sensor such as lighting conditions of the surroundings are useful by the processor for determining time instants where the video provides good quality (e.g. the content is either not too dark nor too bright). The zoom level data can be utilized by the processor to determine time instants where a user is zooming into something within the captured event.

Each type of sensor data may create an array of timestamps (with each timestamp associated with a corresponding data value) and the different timestamps may then combined by the processor into one array using chorological order. For each selected video v, a timestamp array may be provided according to

vidTsᵢ^{v},0≦i<nVidTs (1)

where nVidTs is the number of timestamps identified.

In some embodiments, the video snapshots are determined using the timestamps as an input. For each timestamp, the corresponding video snapshot is determined according to

vidSnapTsᵢ^{v},0≦i<nVidTs (2)

such that vidSnapTsᵢ^{v} is the nearest key frame (I-frame) video in the vicinity of vidTsᵢ^{v}. The nearest key frame boundary for each timestamp may be determined and that video frame may be used as a candidate for a video snapshot. Modern video encoders typically insert key frames in regular intervals into the encoded video stream and to obtain the lowest complexity in retrieving the video snapshot, the time instants are first mapped to key frame boundaries. Once the mapping is done, the video snapshots may be selected by the processor by extracting the video frames using the key frame boundary timestamps. The exact number of video snapshots to be selected is implementation dependent, but selections may include, but are not limited to, video snapshots obtained at regular intervals, video snapshots obtained at random intervals but covering the entire video duration until a certain predefined upload size has been reached, video snapshots whose selection is variable (in time) depending on the importance of the particular timestamp (for example, certain sensor data point may be given preference than other types of timestamps such as by assigning more weight to zooming related timestamps, etc.), or any combination of these.

The apparatus 200 may also include means, such as the processor 202 or the like, for selecting still images for the selected content. See block 412 of FIG. 4. In one embodiment, the apparatus 200 and, more particularly, the processor, may select the still images based on the time the image was taken with respect to the start or end of the selected video. For example, it may be defined that all images taken x seconds before and y seconds after the selected video will be selected. If the start of the selected video is vidTsₛₜₐᵣₜ^{v}, then all images that are taken between vidTsₛₜₐᵣₜ^{v}−x and vidTsₛₜₐᵣₜ^{v} will be selected. Similarly, if the end of the selected video is vidTs_{end}^{v}=vidTsₛₜₐᵣₜ^{v}+vidTs_{dur}^{v}, where vidTs_{dur}^{v} is the duration of the selected video, then all images taken between vidTs_{end}^{v} and vidTs_{end}^{v}+y will be selected. It may also be advantageous to rank the selected images to exclude poor quality images.

As shown in block 414 of FIG. 4, the apparatus 200 may also include means, such as the processor 202 or the like, for performing quality analysis of the video snapshots and still images. The quality analysis performed by the processor may utilize sensor information to determine whether particular video snapshots and still images should be uploaded. For example, sensor information may be used to rank the video snapshots and still images or the video snapshots and still images may be analyzed for quality defects (such darkness, blurriness, etc.). In some embodiments, the quality analysis of block 414 may be optional and only applied when computational complexity of the apparatus is not an issue.

The apparatus 200 may also include means, such as the processor 202 or the like, for creating a first data package to be uploaded to the multi-user content server 106. See block 416 of FIG. 4. The apparatus 200, such as by the processor, may create the first data upload by combining the selected audio track, video snapshots, and optionally still images, along with optional corresponding sensor data. For each selected video snapshot and still image the timestamp with respect to the start of the selected video may also be included in the first data upload. The timestamps of one embodiment may be defined according to

vUplTsᵢ^{v}=vidTsₛₜₐᵣₜ^{v}−vmTs_{z}^{v},0≦z<nTs (3)

where vmTs_{z}^{v} is the start timestamp of a video snapshot or a still image for selected video v and nTs is the number of video snapshots and still images to be uploaded as part of the first data part of the content.

As shown in block 418 of FIG. 4, the apparatus 200 may also include means, such as the processor 202 or the like, for causing transmission of the first data part to the multi-user content server 106.

The apparatus 200 may also include means, such as the processor 202 or the like, for causing transmission of the second data part to the multi-user content server 106. See block 420 of FIG. 4. As noted above, the second data part may include the full audio and video recording or at least a video recording having more frames than the first data part. Optionally, the first data part and the second data part may be transmitted at a same transmission rate or at different transmission rates. However, the second data part generally includes more data and, as such, may take longer to upload, even at a greater data rate, than the first data part. However, the initial provision of the first data part followed by the provision of the second data part permits an end user to have quicker access to the content via the first data part, even though the quality may not be good as is desired, followed by access to a higher quality recording as provided via the second data part.

FIG. 5 illustrates operations that may be provided in some embodiments for rendering content for end users by using the first data part of the content upload. In this regard, the apparatus embodied by the multi-user content server 106 may include means, such as a processor 202, communication interface 206, or the like, for receiving the first data part content upload. See block 502 of FIG. 5. The multi-user content server 106 may also include means, such as a processor 202, memory 204, or the like, for causing the storage of the uploaded content.

As shown in block 504 of FIG. 5, the apparatus embodied by the multi-user content server 106 may also include means, such as a processor 202 or the like, for mapping the uploaded content to a the common timeline. This can be realized, for example, by causing the processor to align the audio tracks for an event uploaded from different users to create the common timeline.

The apparatus embodied by the multi-user content server 106 may also include means, such as a processor 202 or the like, for generating an audio track for the common timeline. See block 506 of FIG. 5. The audio track may be created by the processor, for example, by mixing all overlapping audio tracks as a function of time.

The apparatus embodied by the multi-user content server 106 may also include means, such as a processor 202 or the like, for mapping the video snapshots and still images to the common timeline. See block 508 of FIG. 5. Optionally, the apparatus embodied by the multi-user content server 106 may also include means, such as a processor 202 or the like, for mapping the still images to the common timeline. See block 510 of FIG. 5.

For example, if the position of video v in the timeline is vTimelineTsᵥ, then the video snapshots and still images are positioned as vTimelineTsᵥ+vsTsᵥ^{z} and vTimelineTsᵥ+imgTsᵥ^{w}, respectively, where 0≦z<nVideoSnapShots and 0≦w<nStilllmages describe the number of video snapshots and still images for video v. Still images outside the common timeline (e.g. where no audio track is available) may be, for example, randomly inserted into the common timeline.

As shown in block 512 of FIG. 5, the apparatus embodied by the multi-user content server 106 may also include means, such as a processor 202 or the like, for creating the rendered content, including generating the video track to correspond to the audio track. This can be realized, for example, by providing a video snapshot or image whenever it appears in the common timeline and using that video snapshot or image until the next video snapshot or image appears in the common timeline.

The apparatus embodied by the multi-user content server 106 may also include means, such as a processor 202 or the like, for causing transmission of the rendered content to an end user. See block 514 of FIG. 5.

Additionally, because the second data part comprises content associated with the same audio track as the first data part, the content of the second data part may be associated with the same timeline as the content rendered from the first data part. Upon completing the receiving of the second data part, the apparatus may use the second data part (i.e. the original captured content that was selected for sharing) in providing content to end users.

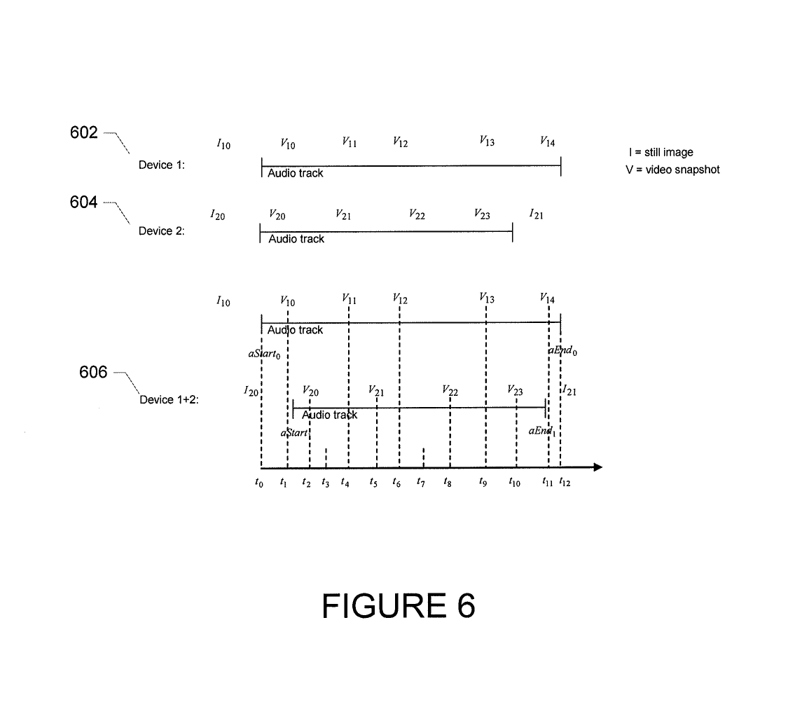

FIG. 6 illustrates an example of content rendering for uploaded input contents from two devices, in accordance with some example embodiments. For the first device (device 1) 602, one still image and five video snapshots are available along with the audio track and for the second device (device 2) 604, two still images and four video snapshots are available. The “device 1+2” 606 in FIG. 6 shows the common timeline for the audio track. The still images and video snapshots are also shown mapped in the common timeline. The audio track is generated for the entire common timeline starting from aStart₀ to aEnd₀. The audio track for time period aStart₀-aStart₁ will be the audio track from device 1, for time period aStart₁-aEnd₁ the audio track will be a mixed version of audio tracks from device 1 and device 2, and for time period aEnd₁-aEnd₀ the audio track will be the audio track from device 1. Naturally, other audio track compositions are possible. The video track is next generated by the processor for the audio track. The video track of this example is composed of the following elements as a function of time, where Vₙ represents the video snapshots and Iₙ represents the still images:

| Time period | Content element |
|---|---|
| t₀-t₁ | I₂₀ |
| t₁-t₂ | V₁₀ |
| t₂-t₃ | V₂₀ |
| t₃-t₄ | I₁₀ |
| t₄-t₅ | V₁₁ |
| t₅-t₆ | V₂₁ |
| t₆-t₇ | V₁₂ |
| t₇-t₈ | I₂₁ |
| t₈-t₉ | V₂₂ |
| t₉-t₁₀ | V₁₃ |
| t₁₀-t₁₁ | V₂₃ |
| t₁₁-t₁₂ | V₁₄ |

As described above, the video snapshots may be used when they appear first in the timeline and, in addition, the three still images may also be inserted into the timeline.

As described above, FIGS. 4 and 5 illustrate flowcharts of an apparatus, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 204 of an apparatus employing an embodiment of the present invention and executed by a processor 202 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as shown by the blocks with dashed outlines. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
determining captured content to be shared in a multi-user environment;
determining a first data part upload of the determined content, wherein the first data part upload comprises audio and one or more video snapshots of the determined content;
causing the first data part upload to be transmitted; and
causing a second data part upload to be transmitted, wherein the second data part upload comprises a video of the determined content that includes more data than the first data part upload.

2. A method according to claim 1 wherein determining the first data part upload comprises selecting the one or more video snapshots based on a timestamp.

3. A method according to claim 1 further comprising determining sensor data corresponding to the captured content.

4. A method according to claim 3 wherein determining the first data part upload comprises selecting video snapshots based on a timestamp and the sensor data.

5. A method according to claim 1 wherein the first data part upload further comprises one or more still images.

6. A method according to claim 5 further comprising determining sensor data corresponding to the captured content and wherein determining the first data part upload comprises selecting video snapshots or still images based on a timestamp and the sensor data.

7. A method comprising:
receiving a first data part upload of content, wherein the first data part upload comprises audio and one or more video snapshots of the content;
determining a common timeline for the uploaded content;
generating an audio track for the common timeline;
mapping the one or more video snapshots to the common timeline;
generating rendered content for the common timeline using the audio track and the mapped video snapshots; and
causing the rendered content to be transmitted.

8. A method according to claim 7 wherein the first data part upload further comprises one or more still images and wherein the method further comprises mapping the one or more still images to the common timeline.

9. A method according to claim 7 wherein the determining a common timeline for the uploaded content comprises aligning two or more uploaded audio tracks.

10. A method according to claim 7 wherein the generating an audio track for the common timeline comprises mixing two or more overlapping audio tracks as a function of time.

11. A method according to claim 7 wherein the generating rendered content for the common timeline further comprises providing a first video snapshot when it first appears in the common timeline and replacing the first video snapshot with a second video snapshot when the second video snapshot first appears in the common timeline.

12. A method according to claim 8 wherein the one or more still images having a timestamp outside the common timeline are randomly mapped to the common timeline.

13. An apparatus comprising at least one processor and at least one memory including computer program instructions, the at least one memory and the computer program instructions configured to, with the at least one processor, cause the apparatus at least to:
determine captured content to be shared in a multi-user environment;
determine a first data part upload of the determined content, wherein the first data part upload comprises audio and one or more video snapshots of the determined content;
cause the first data part upload to be transmitted; and
cause a second data part upload to be transmitted, wherein the second data part upload comprises a video of the determined content that includes more data than the first data part upload.

14. An apparatus according to claim 13 wherein the at least one memory and the computer program instructions are further configured to, with the at least one processor, cause the apparatus to select the one or more video snapshots in the first data part upload based on one or more timestamps.

15. An apparatus according to claim 13 wherein the at least one memory and the computer program instructions are further configured to, with the at least one processor, cause the apparatus to determine sensor data corresponding to the captured content.

16. An apparatus according to claim 15 wherein the at least one memory and the computer program instructions are further configured to, with the at least one processor, cause the apparatus to select the one or more video snapshots in the first data part upload based on one or more timestamps and the sensor data.

17. An apparatus according to claim 13 wherein the first data part upload further comprises one or more still images.

18. An apparatus according to claim 17 wherein the at least one memory and the computer program instructions are further configured to, with the at least one processor, cause the apparatus to determine sensor data corresponding to the captured content and select the one or more video snapshots or the one or more still images in the first data part upload based on one or more timestamps and the sensor data.

19. An apparatus comprising at least one processor and at least one memory including computer program instructions, the at least one memory and the computer program instructions configured to, with the at least one processor, cause the apparatus at least to:
receive a first data part upload of content, wherein the first data part upload comprises audio and one or more video snapshots of the content;
determine a common timeline for the uploaded content;
generate an audio track for the common timeline;
map the one or more video snapshots to the common timeline;
generate rendered content for the common timeline using the audio track and the mapped video snapshots; and
cause the rendered content to be transmitted.

20. An apparatus according to claim 19 wherein the first data part upload further comprises one or more still images and wherein the at least one memory and the computer program instructions are further configured to, with the at least one processor, cause the apparatus to map the one or more still images to the common timeline.

21.-48. (canceled)
